(19) United States
(12) Patent Application Publication
(10) Pub. No.: US 2007/0241527 A1
(43) Pub. Date: Oct. 18, 2007

(54) Vehicle suspension with resilient rod linkage

(75) Inventor: Tjong Lie, Naperville, IL (US)

Correspondence Address: CARLSON, GASKEY & OLDS, P.C., 400 WEST MAPLE ROAD, SUITE 350, BIRMINGHAM, MI, 48009, US

(73) Assignee: ArvinMeritor Technology, LLC

(21) Appl. No.: 11/405,791

(22) Filed: Apr. 18, 2006

(51) Int. Cl. B60G 3/00; B60G 9/00

(52) U.S. Cl. 280/124.153; 280/124.157; 280/124.116; 280/124.167

(57) ABSTRACT

A vehicle suspension system utilizes a resilient rod and bracket configuration to replace standard torque rods. Resilient rods are used to couple an axle member to a vehicle member. The axle member includes an axle bracket and the vehicle member includes a vehicle bracket. Upper and lower resilient rods are coupled to the axle and vehicle brackets at each axle end. The resilient rods are pogo rods that utilize a pair of resilient grommets at each rod end that are compressed against a bracket flange by a pair of rigid cups to provide a resilient mount interface. This resilient mount interface at each rod end allows relative movement between the axle and vehicle brackets and each rod in up to ten degrees of freedom.

### TECHNICAL FIELD

The subject invention relates to a vehicle suspension that utilizes a unique pogo rod and bracket configuration to replace standard torque rods for controlling suspension and axle travel.

### BACKGROUND OF THE INVENTION

Vehicle suspension systems are used to absorb road load inputs and other vibrations to provide a smooth and comfortable ride. Vehicle suspension systems include various components that couple an axle member to a vehicle frame or sub-frame. A typical suspension system includes upper and lower torque rods that extend between each end of the axle member and the vehicle frame. Each end of the torque rod is connected to an associated vehicle or axle bracket with a bushing mount. This requires complicated bracket assemblies and multiple fastening elements, which is undesirable.

Vehicle suspension systems also often include a stabilizer bar that is used to increase roll rigidity and improve steering stability. Typically, the stabilizer bar is connected to lower control arms, which are mounted to a wheel component, such as a knuckle. To further improve suspension characteristics, a transverse torque rod is often used to connect one axle end to the vehicle frame at an opposite axle end. Again, these connection interfaces for the stabilizer bar and transverse torque rods require complicated bracket configurations.

Further, these bushing and bracket type connection interfaces have limited degrees of relative movement. Suspension systems are needed that more effectively absorb road load inputs and vibrations without adding additional hardware, which overcomplicates the system. Thus, there is a need for a simplified suspension connection interface between an axle and a vehicle frame that provides a more comfortable vehicle ride.

### SUMMARY OF THE INVENTION

A vehicle suspension system utilizes a resilient rod and bracket configuration to replace standard torque rods. Resilient rods are used to couple an axle member to a vehicle member. The axle member includes an axle bracket and the vehicle member includes a vehicle bracket. Upper and lower resilient rods are coupled to the axle and vehicle brackets at each axle end.

The resilient rods are pogo rods that utilize a pair of resilient grommets at each rod end that are compressed against a bracket flange by a pair of rigid cups to provide a resilient mount interface. This resilient mount interface at each rod end allows relative movement between the axle and vehicle brackets and each rod end in up to ten degrees of freedom.

The vehicle brackets and axle brackets are simplified as each bracket has to have only one opening for each rod end. Thus, the axle bracket only has two (2) openings, one for the upper resilient rod and one for the lower resilient rod. Correspondingly, the vehicle bracket only has two (2) openings, one each for the upper and lower resilient rods.

The pogo rods can be used to replace standard torque rods in all locations within a vehicle suspension, including a transverse torque rod. Further, the pogo rods can be used to replace linkage traditionally used for connecting a stabilizer bar between the axle member and the vehicle member. Further, the pogo rods are easily incorporated into suspensions for I beam or tubular front or rear axles.

These and other features of the present invention can be best understood from the following specification and drawings, the following of which is a brief description.

### BRIEF DESCRIPTION OF THE DRAWINGS

FIG. 1 is a schematic view of an axle assembly and a vehicle suspension system incorporating the subject invention.

FIG. 2 is a schematic side view of one suspension configuration.

FIG. 3 is a perspective view of one suspension rod assembly incorporating the subject invention.

FIG. 4 is a second view of one end of the suspension rod assembly of FIG. 3.

FIG. 5 is a side view of one example bracket and rod configuration for an I-beam axle member.

FIG. 6 is one example configuration of a bracket as used in the configuration of FIG. 5.

FIG. 7 is one example rod and bracket configuration for a tubular axle.

FIG. 8 is a schematic top view of a five rod configuration for an axle assembly.

FIG. 9 is a schematic view of a transverse rod connection for a non-drive axle.

FIG. 10 is a perspective view of a transverse rod connection for a drive axle.

FIG. 11 is a schematic view of a stabilizer bar connection.

FIG. 12 is a magnified view of one connection interface of a stabilizer bar.

FIG. 13 is a schematic side view of a leaf spring suspension configuration.

FIG. 14 is a schematic view showing rod placement for the leaf spring suspension of FIG. 13.

FIG. 15 is one example shock absorber configuration.

### DETAILED DESCRIPTION OF THE PREFERRED EMBODIMENT

FIG. 1 shows an axle 10 extending between first 12 and second 14 wheels. A suspension system 16 is mounted between the axle 10 and a vehicle sub-frame or frame 18. The axle 10 includes a first axle end 20 at the first wheel 12 and a second axle end 22 at the second wheel 14. The first 20 and second 22 axle ends each include an axle bracket 24. A corresponding vehicle bracket 26 is also mounted to the vehicle frame 18 adjacent each of the first 20 and second 22 axle ends. Pogo rods 30 extend between each axle bracket 24 and corresponding vehicle bracket 26. The pogo rods 30 replace standard torque rods that have been traditionally used in vehicle suspensions.

In the example shown, each of the first 20 and second 22 axle ends includes an upper pogo rod 30a and a lower pogo rod 30b (indicated by dashed lines). The suspension system 16 could also include a transverse pogo rod 32 that extends from an axle bracket 34 at one axle end to a vehicle bracket 36 mounted to the vehicle frame 18 at an opposite axle end.

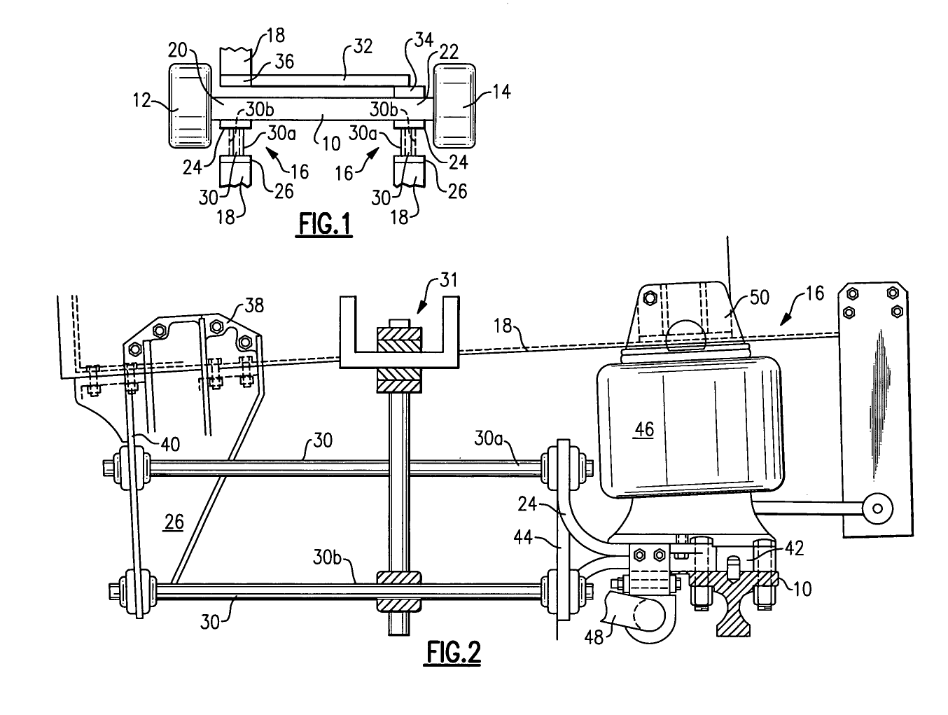

One end of the suspension system 16 is shown in greater detail in FIG. 2. The vehicle bracket 26 includes a vehicle mount portion 38 and a flange portion 40. The axle bracket 24 includes an axle mount portion 42 and a flange portion 44. The upper 30a and lower 30b pogo rods extend between the flange portions 40, 44 and are generally parallel to each other. An air spring 46 is positioned above the axle 10 and a stabilizer bar 48 is mounted to the axle 10. The air spring 46 is also mounted to the vehicle frame 18 by bracket 50. The stabilizer bar 48 extends from one axle end to an opposite axle end. The stabilizer bar connection interface to the axle 10 will be discussed in greater detail below.

In this example, the axle 10 comprises a non-drive axle having an I-beam configuration as shown. The axle mount portion 42 of the axle bracket 24 is mounted to an upper surface of the axle 10. The vehicle mount portion 38 of the vehicle bracket 26 is mounted to the vehicle frame 18, which could comprise a longitudinally extending channel beam, for example. The upper 30a and lower 30b pogo rods extend generally parallel to each other between the flange portions 40, 44 of the vehicle 26 and axle 24 brackets. Another pogo connection 31 extends between the vehicle frame 18 and lower pogo rod 30b as shown.

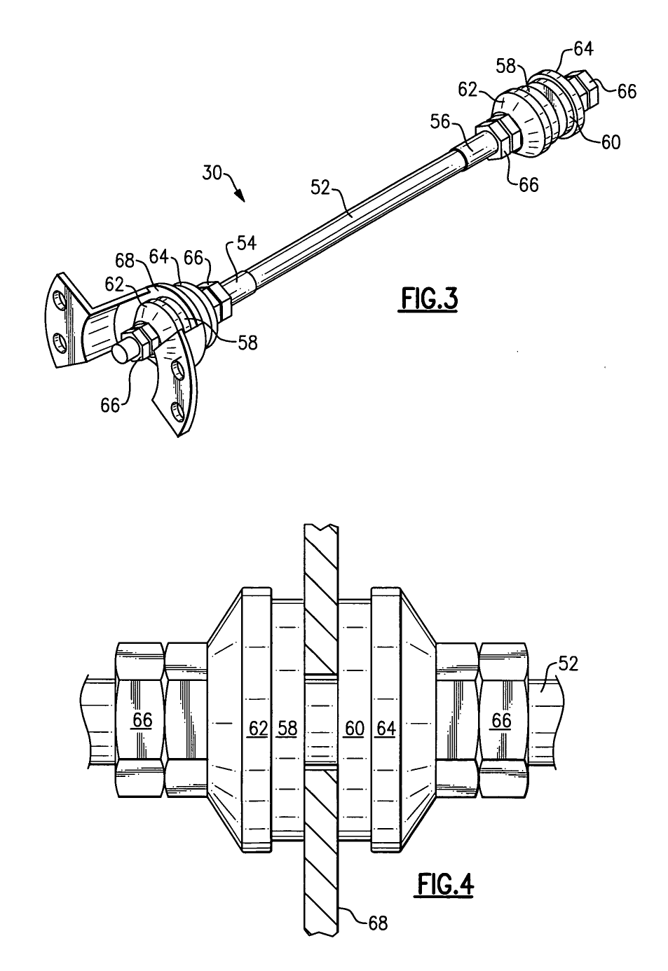

The pogo rod 30 is shown in greater detail in FIGS. 3-4. Each of the upper 30a, lower 30b, and transverse 32 pogo rods has a configuration similar to that shown in FIGS. 3-4. The pogo rod 30 includes a rod body 52 having a first rod end 54 and a second rod end 56. At each of the first 54 and second 56 rod ends are first 58 and second 60 elastomeric components. Preferably, the first 58 and second 60 elastomeric components comprise resilient grommets made from urethane material, however, other resilient materials could also be used. First 62 and second 64 rigid cups are positioned outwardly of the first 58 and second 60 elastomeric components such that the first 58 and second 60 elastomeric components are sandwiched between the first 62 and second 64 rigid cups.

Preferably, the first 54 and second 56 rods ends are threaded such that the first 62 and second 64 rigid cups are threadably attached to the rod body 52. The first 62 and second 64 rigid cups are preferably formed from a steel material, however, other rigid materials could also be used. Jam nuts 66 could optionally be used to further secure and hold the first 62 and second 64 rigid cups in place.

As shown in FIG. 4, the first 58 and second 60 elastomeric components are pressed against a bracket flange 68. An example bracket flange 68 is shown in FIG. 4. This example bracket flange 68 corresponds to the flange portions 40, 44 of the vehicle bracket 26 and axle bracket 24. The first 62 and second 64 rigid cups are threaded onto the rod body 52 to compress the first 58 and second 60 elastomeric components directly against the bracket flange 68. Nuts 66 are used to hold the first 62 and second 64 rigid cups in place.

The combination of the first 58 and second 60 elastomeric components, and the first 62 and second 64 rigid cups cooperate with the bracket flange 68 to allow relative movement in up to ten degrees of freedom. Thus, the rod body 52 can rotate, twist, and move axially relative to the vehicle 26 and axle 24 brackets.

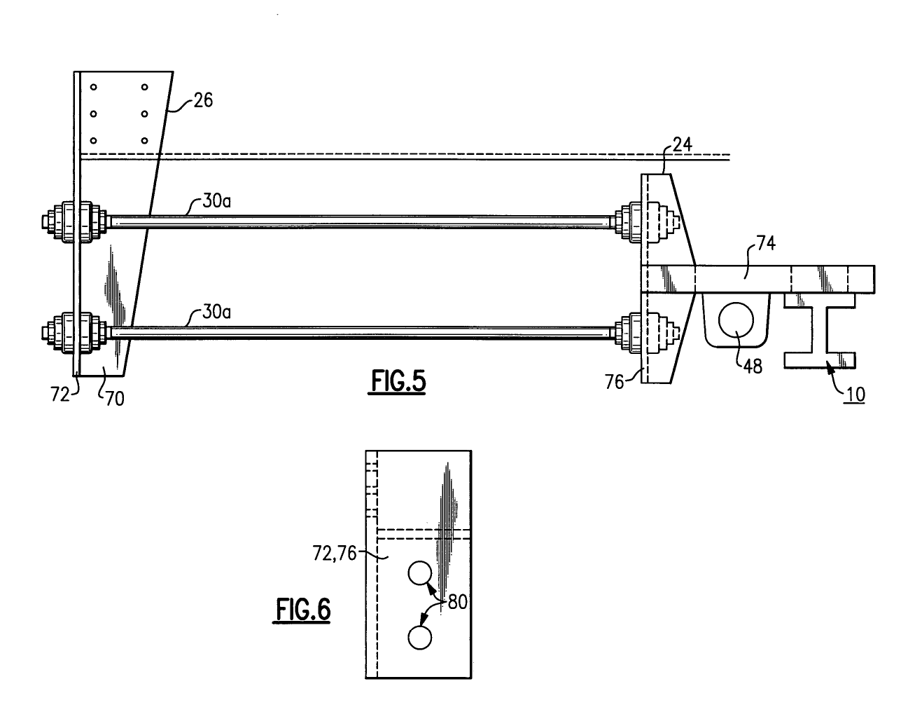

Further, the vehicle 26 and axle 24 brackets are significantly simplified compared to traditional torque rod mounts. One example of this simplified bracket configuration is shown in greater detail in FIGS. 5-6. The vehicle bracket 26 includes a first flat portion 70 that attaches to the vehicle frame and a second flat portion 72 that receives the upper 30a and lower 30b pogo rods. The first 70 and second 72 flat portions are preferably orientated in the shape of an L.

The axle bracket 24 includes a first flat portion 76 that mounts to the axle 10 and a second flat portion 78 that receives the upper 30a and lower 30b pogo rods. The first 76 and second 78 flat portions are preferably orientated in the shape of a T.

For both second flat portions 72, 78, only two (2) openings 80 are required to be formed in the respective vehicle 26 and axle 24 bracket, as shown in FIG. 6. This greatly simplifies manufacturing of the vehicle 26 and axle 24 brackets. The vehicle 26 and axle 24 brackets can easily be made by stamping, casting, or any other manufacturing process, and require minimal final machining.

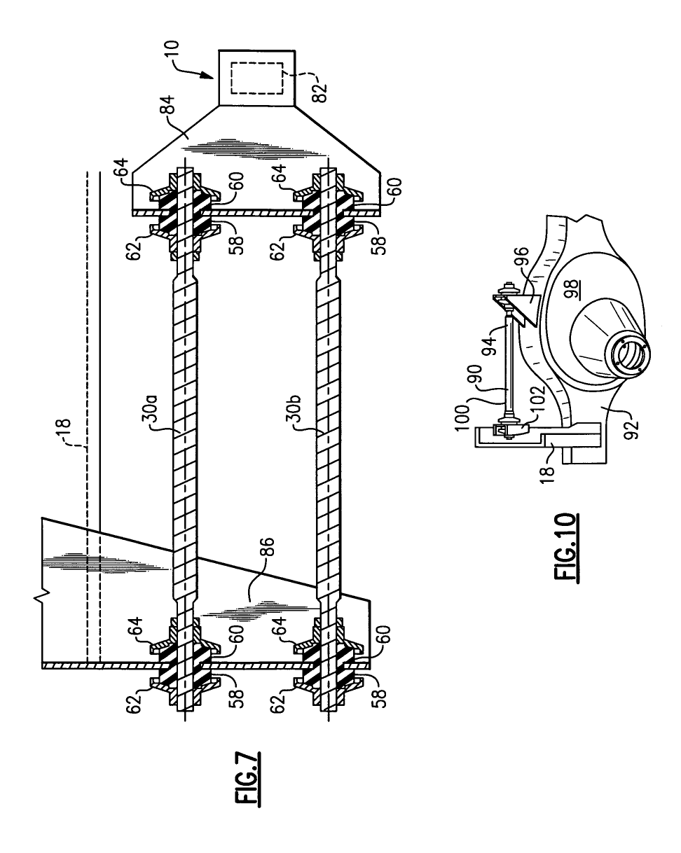

Another example configuration is shown in FIG. 7. In this example, the axle 10 is a tubular axle 82 with an axle bracket 84 that is directly welded to the tubular axle 82. A vehicle bracket 86, similar to vehicle bracket 26 is mounted to the vehicle frame. Upper 30a and lower 30b pogo rods extend between the vehicle bracket 86 and axle bracket 84 in a manner similar to that shown in FIGS. 2 and 5. Upper 30a and lower 30b pogo rods are positioned at each end of the tubular axle 82 as shown in FIG. 1.

By welding the axle bracket 84 to the tubular axle 82, traditionally used U-bolt attachments are eliminated, which results in weight and cost savings. Further, no re-torque is required, which reduces maintenance.

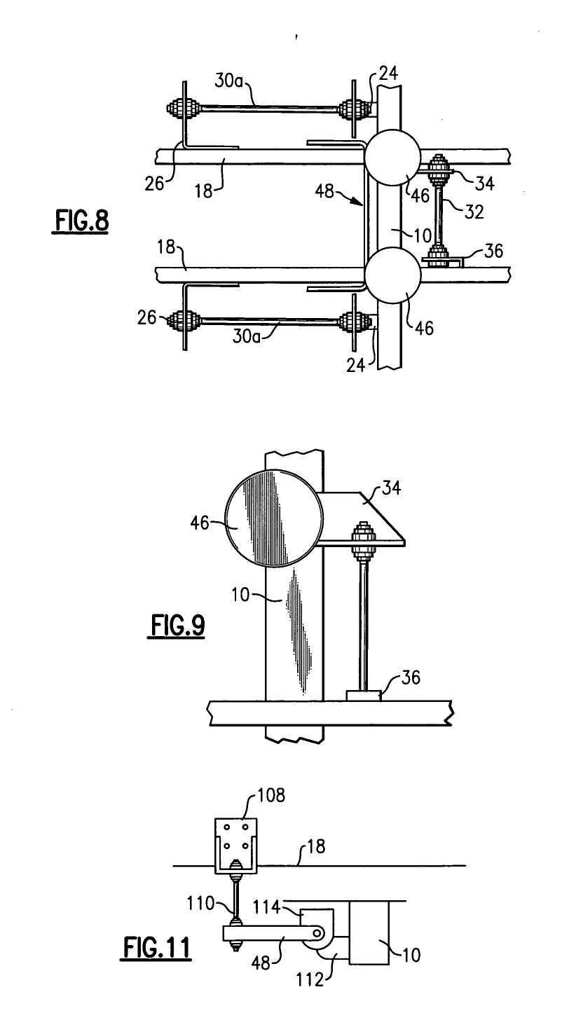

Another example of a five (5) pogo rod configuration, similar to that of FIG. 1, is shown in FIG. 8. This configuration includes both a stabilizer bar 48 and a transverse pogo rod 32. Upper 30a and lower 30b pogo rods (only the upper pogo rods 30a are visible) extend between vehicle 26 and axle 24 brackets at each end of the axle 10. Although not clear from this view, upper pogo rods 30a are mounted vertically above lower pogo rods 30b, i.e., the lower pogo rods 30b are directly underneath the upper pogo rods 30a shown in FIG. 8. A fifth pogo rod, i.e. the transverse pogo rod 32 extends from an axle bracket 34 at one axle end to a vehicle bracket 36 at an opposite axle end. The transverse pogo rod 32 is preferably positioned on one longitudinal side of the air springs 46 (FIG. 9) while the stabilizer bar 48 is positioned on an opposite longitudinal side of the air springs 46 (FIG. 12).

The fifth pogo rod could be eliminated by orientating either of the upper 30a and lower 30b pogo rods at each end of the axle 10 in a V-shaped configuration. The upper pogo rods 30a would form an upper V-shape, and the lower pogo rods 30b would form a lower V-shape. Apexes of the upper and lower V-shapes would be positioned at the axle 10.

FIG. 10 shows an alternate configuration for a transverse pogo rod 90 for a drive axle 92. In this configuration, one end 94 of the transverse pogo rod 90 is mounted to a bracket 96 at a carrier portion 98 of the drive axle 92, and an opposite rod end 100 is mounted to a bracket 102 fixed to the vehicle frame 18. The carrier portion 98 is preferably located near a center of the drive axle 92, thus the transverse pogo rod 90 is generally shorter in length compared to the configuration shown in FIGS. 8 and 9.

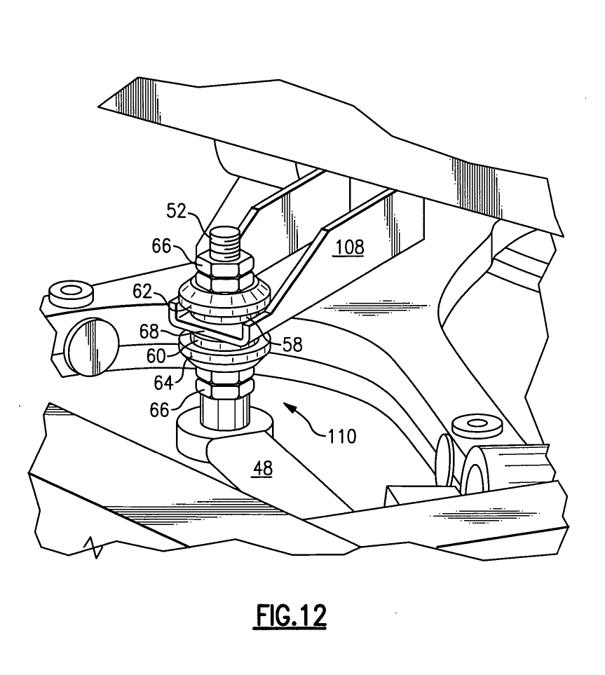

Pogo rods 30 can also be used for a linkage assembly for the stabilizer bar 48 as shown in FIGS. 11-12. A vehicle bracket 108 is mounted to the vehicle frame 18 at each end of the stabilizer bar 48. A pogo link rod 110 is mounted to each stabilizer bar end and an associated vehicle bracket 108 as shown in FIG. 12 (only one end is shown in FIG. 12, however the opposite end has a similar connection).

The stabilizer bar 48 is also connected to the axle 10 as shown FIG. 11. The axle 10 includes a bracket 112 that supports a clamp 114 that surrounds a middle portion of the stabilizer bar 48, as shown in FIG. 12.

As shown in FIG. 12, the pogo link rod 110 includes first 62 and second 64 rigid cups that compress first 58 and second 60 elastomeric components directly against bracket 108 in manner similar to that shown in FIG. 4. As can be appreciated, the rod is much shorter in this embodiment than in the prior embodiments.

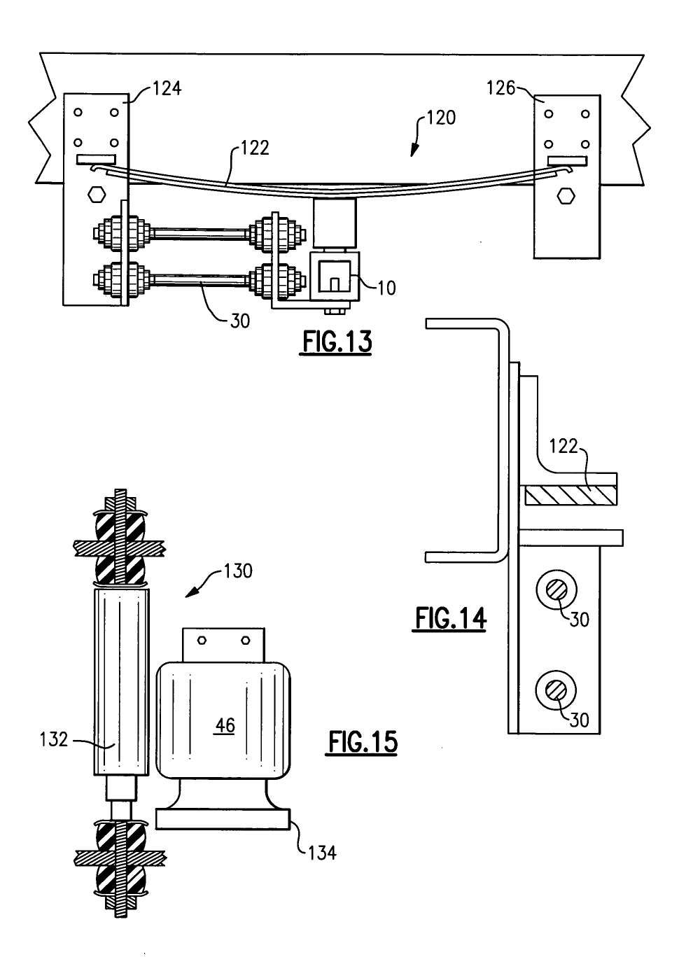

Another suspension embodiment is shown in FIGS. 13 and 14. In this configuration, a mechanical suspension 120 includes a plurality of leaf springs 122 that extend between first 124 and second 126 brackets. The leaf springs 122 extend transversely relative to axle 10. Pogo rods 30 used in this configuration need to clear the leaf springs 122 and thus are positioned outboard of the leaf springs 122 as shown in FIG. 14.

FIG. 15 shows one example shock system 130 that can be incorporated into any of the vehicle suspensions described above. The shock system 130 includes a shock absorber 132 that works in conjunction with the air spring 46 to absorb road load inputs. The shock absorber 132 is mounted to an axle bracket 134 at one end, and is mounted to a vehicle bracket 136 at an opposite end.

The subject invention provides a suspension system that is lighter and more cost effective than traditional trailing arm front air suspensions. Pogo rods are used as a linkage control to replace traditional torque rods. This significantly reduces system cost and the associated brackets are drastically simplified with regard to design and fastener requirements.

A standard five (5) pogo rod configuration provides two upper trailing arms, two lower trailing arms, and a transverse arm. As discussed above, the transverse arm could be removed by mounting the upper trailing arms in a first V, and mounting the lower trailing arms in a second V, to absorb transverse loads in addition to fore-and-aft loadings. Sway is controlled by using smaller pogo rods as the linkage for the stabilizer bar.

The bracket designs at both the vehicle frame and axle are simplified as only one hole is required for attaching each pogo rod end. The hole has the same size for all attachments. This eliminates bosses and fasteners traditionally needed to attach a typical straddle mount torque rod.

The subject invention can be used for many different axles including an I-beam front axle, a tubular box section front axle, or any truck or trailer rear axle such as a tag axle, pusher axle, drive axle, etc. Further, by having the upper and lower pogo rods parallel to each other, brake dive, i.e. steering effect, issues are reduced. These issues can be a problem for a leaf spring or traditional trailing arm suspension.

Although a preferred embodiment of this invention has been disclosed, a worker of ordinary skill in this art would recognize that certain modifications would come within the scope of this invention. For that reason, the following claims should be studied to determine the true scope and content of this invention.

What is claimed is:

1. A vehicle suspension system comprising:
an axle member defining a lateral axis and having a first end and a second end;
a first upper rod and a first lower rod positioned at said first end of said axle member;
a second upper rod and a second lower rod positioned at said second end of said axle member wherein each of said first and second upper rods and said first and second lower rods extends along an axis that is transverse to said lateral axis and that extends between spaced rod ends, and includes a first attachment interface connecting each of said first and second upper rods and said first and second lower rods to said axle member and a second attachment interface adapted to connect each of said first and second upper rods and said first and second lower rods to a vehicle member; and
wherein said first and second attachment interfaces each comprise a resilient mount coupled to a bracket member.

2. The vehicle suspension system according to claim 1 wherein said resilient mount comprises at least one elastomeric component mounted to each rod end.

3. The vehicle suspension system according to claim 2 including at least one rigid cup in abutting engagement with each elastomeric component.

4. The vehicle suspension system according to claim 3 wherein said bracket member includes a flange portion and wherein said at least one elastomeric component comprises a first elastomeric component positioned on one side of said flange portion and a second elastomeric component positioned on an opposite side of said flange portion, and said at least one rigid cup comprises a first rigid cup positioned against said first elastomeric component and a second rigid cup positioned against said second elastomeric component such that said first and second elastomeric components are sandwiched between said first and second rigid cups.

5. The vehicle suspension system according to claim 4 wherein said bracket member includes a mount portion adapted for attachment to one of said axle member and the vehicle member.

6. The vehicle suspension system according to claim 1 including a transverse rod having one end connected to said first end of said axle member at a third attachment interface and an opposite end adapted for connection to the vehicle member at said second end of said axle member at a fourth attachment interface wherein said third and fourth attachment interfaces each comprise a resilient mount coupled to a bracket member.

7. The vehicle suspension system according to claim 1 wherein said resilient mount allows each of said first and second upper rods and said first and second lower rods to move in multiple degrees of freedom including at least rotational movement and axial movement.

8. The vehicle suspension system according to claim 1 wherein said axle member comprises an I-beam.

9. The vehicle suspension system according to claim 1 wherein said axle member comprises a tube.

10. The vehicle suspension system according to claim 1 wherein said axle member comprises a drive axle.

11. The vehicle suspension system according to claim 1 including a stabilizer bar having one end coupled to said first end of said axle member and an opposite end coupled to said second end of said axle member and wherein each end of said stabilizer bar is adapted for connection to the vehicle member by a link rod, said link rod having a resilient mount interface for attachment to the vehicle member and to said stabilizer bar.

12. A vehicle suspension system comprising:
an axle member defining a lateral axis and having a first axle end and a second axle end;
a first bracket mounted to said first axle end;
a second bracket adapted for mounting to a vehicle member adjacent said first axle end;
a first upper pogo rod coupled to said first bracket and coupled to said second bracket;
a first lower pogo rod coupled to said first bracket and coupled to said second bracket;
a third bracket mounted to said second axle end;
a fourth bracket adapted for mounting to a vehicle member adjacent said second axle end;
a second upper pogo rod coupled to said third bracket and coupled to said fourth bracket; and
a second lower pogo rod coupled to said third bracket and coupled to said fourth bracket.

13. The vehicle suspension system according to claim 12 wherein each of said first and second upper pogo rods and each of said first and second lower pogo rods comprises a rod body having a first rod end and a second rod end, a first elastomeric assembly mounted to said first rod end, a second elastomeric assembly mounted to said second rod end, a first rigid assembly cooperating with said first elastomeric assembly to mount said first rod end to a first bracket flange of one of said first and second brackets, and a second rigid assembly cooperating with said second elastomeric assembly to mount said second rod end to a second bracket flange of another of said first and second brackets.

14. The vehicle suspension system according to claim 13 wherein said first and second elastomeric assemblies each include first and second resilient grommets positioned on opposing sides of said first and second bracket flanges and wherein said first and second rigid assemblies each include first and second rigid cups positioned adjacent to said first and second resilient grommets such that said first and second resilient grommets are pressed against said first and second bracket flanges by said first and second rigid cups.

15. The vehicle suspension system according to claim 12 including a stabilizer bar having one end coupled to said first axle end and an opposite end coupled to said second axle end and wherein each end of said stabilizer bar is adapted for connection to the vehicle member by a link pogo rod, said link pogo rod having rod ends, with a resilient mount interface at each rod end that includes first and second resilient grommets sandwiched between first and second rigid cups.

16. The vehicle suspension system according to claim 12 including a transverse pogo rod extending between two rod ends, and having one rod end connected to said first axle end and an opposite rod end adapted for connection to the vehicle member at said second axle end wherein said transverse pogo rod includes a resilient mount interface at each rod end that comprises first and second resilient grommets sandwiched between first and second rigid cups.

17. The vehicle suspension system according to claim 12 wherein each of said first and second upper pogo rods and each of said first and second lower pogo rods extend between two rod ends, and each rod end is movable within multiple degrees of freedom including at least rotational and axial movement within said first and second brackets.

18. A suspension rod and bracket assembly comprising:
a first suspension bracket having a first flange portion and an axle mount portion adapted for attachment to an axle member;
a second suspension bracket having a second flange portion and a vehicle mount portion adapted for attachment to a vehicle member;
a rod body having a first rod end attached to said first flange portion and a second rod end attached to said second flange portion;
a first pair of resilient grommets positioned on opposite sides of said first flange portion;
a first pair of rigid cups engaging said first pair of resilient grommets to clamp said first pair of resilient grommets against said first flange portion;
a second pair of resilient grommets positioned on opposite sides of said second flange portion; and
a second pair of rigid cups engaging said second pair of resilient grommets to clamp said second pair of resilient grommets against said second flange portion.
